(19) United States
(12) Patent Application Publication
(10) Pub. No.: US 2024/0413425 A1
(43) Pub. Date: Dec. 12, 2024

(54) MANAGING HEAT TRANSFER TO A BATTERY

(71) Applicant: Telefonaktiebolaget LM Ericsson (publ), Stockholm (SE)

(72) Inventors: Konstantinos VANDIKAS, Solna (SE); Lackis ELEFTHERIADIS, Valbo (SE); Kristijonas CYRAS, San Jose, CA (US); Athanasios KARAPANTELAKIS, SOLNA (SE); Cecilia NYSTRÖM, STOCKHOLM (SE); Divya SACHDEVA, NEW DELHI (IN); Marin ORLIC, BROMMA (SE); Gabriella NORDQUIST, STOCKHOLM (SE)

(73) Assignee: Telefonaktiebolaget LM Ericsson (publ), Stockholm (SE)

(21) Appl. No.: 18/703,197

(22) PCT Filed: Feb. 8, 2022
(86) PCT No.: PCT/EP2022/052925

§ 371 Date: Apr. 19, 2024

(30) Foreign Application Priority Data
Oct. 22, 2021 (GR) 20210100726

(51) Int. Cl. H01M 10/633; G06N 20/00; H01M 10/613; H01M 10/6567

(52) U.S. Cl. CPC H01M 10/633; G06N 20/00; H01M 10/613; H01M 10/6567

(57) ABSTRACT

Embodiments disclosed herein relate to methods and apparatus for managing heat transfer to a battery. In one embodiment there is provided a method for managing heat transfer to a battery (105) electrically coupled to an electronic device. The method comprises determining a battery temperature of the battery (210) and a predicted heat source parameter associated with the electronic device (215). A battery heat transfer action (220) in a thermal medium (120b, 320hc) coupled between the battery and the electronic device is performed dependent on the predicted heat source parameter (453h) and a difference between a prescribed wanted battery temperature (453w) and the determined battery temperature (453b).

### TECHNICAL FIELD

Embodiments disclosed herein relate to methods and apparatus for managing heat transfer to a battery, an array of batteries or a battery enclosure.

### BACKGROUND

Batteries used for radio units and other electronic devices are designed to operate optimally within certain temperature ranges. Temperatures above or below the prescribed operating temperatures can result in reduced battery capacity, poor battery performance, reduced battery life and even damage to the battery.

To address these issues, batteries may be constructed using special electrolyte and/or insulation materials, however this adds to the cost of the battery. Temperature differences with the ambient temperature of the surrounding environment may be used to control battery temperature, however this is often not enough to achieve a prescribed temperature of the battery. Electrically powered fans may be used for reducing battery temperature and similarly, electrically powered heaters may be used for increasing battery temperature. Liquid cooling may also be used, see for example: https://www.nokia.com/blog/water-cool-new-way-take-heat-base-station-site-energy-costs/However, these solutions require the use of additional power which may need to be provided by the battery itself, again reducing battery capacity and life.

These problems can be exacerbated when the battery is remotely located, for example to power a Remote Radio Unit (RRU) or other electronic device. Such battery and electronic devices systems may be located in hard to access locations such as mountains, rural areas and deserts. Such areas may not be well served by electrical power infrastructure, for example due to unreliable centralized supply, solar cells, wind turbines and the like, and may also be located in areas of extreme ambient temperatures.

### SUMMARY

In one aspect, there is provided a method for managing heat transfer to a battery electrically coupled to an electronic device. The method comprises determining a battery temperature of the battery and a predicted heat source parameter associated with the electronic device, and performing a battery heat transfer action in a thermal medium coupled between the battery and the electronic device dependent on the predicted heat source parameter and a difference between a prescribed battery temperature and the determined battery temperature.

This allows the battery temperature to be managed using heat generated by the electronic device, for example where a battery is used to provide power support for a RRU. The heat generated by the electronic device would otherwise be wasted but according to some embodiments can be used to achieve an optimum battery temperature to improve battery performance, battery life and other battery related characteristics. In addition, some embodiments reduce the amount of energy wasted from the electronic device whilst also reducing the energy required to maintain the battery at a prescribed temperature, for example because heaters or fans are not required. Reducing overheating of the electronic device improves device life, operation and utilization. The temperature management may also be dynamic and linked to the operation of the battery, for example charging or discharging, idle or under heavy load.

The temperature management of the battery may be based on learning from historical values of the predicted heat source parameter and the determined battery temperature, as well as other parameters described herein.

In another aspect there is provided a method of training a first machine learning agent to perform a battery heat transfer action in a thermal medium coupled between a battery and an electronic device and training a second machine learning agent to perform an electronic device cooling action in a device cooling thermal medium coupled between the electronic device and a cold source. The method comprises updating state space values comprising a determined battery temperature, a predicted heat source parameter, a prescribed battery temperature, a prescribed device temperature and a cold source parameter. The predicted heat source parameter, the prescribed device temperature and the cold source parameter are input into the first machine learning agent to generate an electronic device cooling action. The determined battery temperature, the predicted heat source parameter and the prescribed battery temperature are input into the second machine learning agent to generate a battery heat transfer action. The state space values are input into the first and second agents in the same time period. The first machine learning agent is rewarded dependent on a difference between the predicted heat source parameter and the prescribed device temperature. The second machine learning agent is rewarded dependent on a difference between the determined battery temperature and the prescribed battery temperature. The updating, inputting and rewarding is repeated until a training threshold condition is reached.

In another aspect there is provided an apparatus for managing heat transfer to a battery electrically coupled to an electronic device. The apparatus comprising a processor and memory containing instructions executable by said processor to determine a battery temperature of the battery and a predicted heat source parameter associated with the electronic device; and to perform a battery heat transfer action in a thermal medium coupled between the battery and the electronic device dependent on the predicted heat source parameter and a difference between a prescribed battery temperature and the determined battery temperature.

In another aspect there is provided an apparatus for training a first machine learning agent to perform a battery heat transfer action in a thermal medium coupled between a battery and an electronic device and training a second machine learning agent to perform an electronic device cooling action in a device cooling thermal medium coupled between the electronic device and a cold source. The apparatus comprising a processor and memory containing instructions executable by said processor to update state space values comprising a determined battery temperature, a predicted heat source parameter, a prescribed battery temperature, a prescribed device temperature and a cold source parameter. The predicted heat source parameter, the prescribed device temperature and the cold source parameter are input into the first machine learning agent to generate an electronic device cooling action. The determined battery temperature, the predicted heat source parameter and the prescribed battery temperature are input into the second machine learning agent to generate a battery heat transfer action. The state space values are input into the first and second agents in the same time period. The first machine learning agent is rewarded dependent on a difference between the predicted heat source parameter and the prescribed device temperature. The second machine learning agent is rewarded dependent on a difference between the determined battery temperature and the prescribed battery temperature. The update, input and reward steps are repeated until a training threshold condition is reached.

According to certain embodiments described herein there is provided a system comprising: a battery electrically coupled to an electronic device; a thermal medium coupled between the battery and the electronic device; a device cooling thermal medium coupled between the electronic device and a cold source and an apparatus described herein described herein

According to certain embodiments described herein there is provided a computer program comprising instructions which, when executed on a processor, causes the processor to carry out the methods described herein. The computer program may be stored on a non-transitory computer readable media.

### BRIEF DESCRIPTION OF DRAWINGS

For a better understanding of the embodiments of the present disclosure, and to show how it may be put into effect, reference will now be made, by way of example only, to the accompanying drawings, in which:

+

FIG. 1 is a schematic diagram illustrating a system for managing heat transfer to a battery according to an embodiment;

FIG. 2 is a flow chart of a method of managing heat transfer to a battery according to an embodiment;

FIG. 3 illustrates thermal medium arrangements for performing heat transfer actions according to embodiments;

FIG. 4 illustrates a controller and the use of machine learning agents to manage heat transfer to a battery according to an embodiment;

FIGS. 5a and 5b is a sequence diagram illustrating training of machine learning agents to manage heat transfer to a battery according to an embodiment; and

FIG. 6 is a sequence diagram illustrating operation of trained machine learning agents to manage heat transfer to a battery according to an embodiment.

### DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Embodiments described herein relate to methods and apparatus for managing heat transfer to a battery which is electrically coupled to an electronic device such as a Remote Radio Unit (RRU) or an Internet of Things (IoT) edge server. Heat generated and dissipated by the electronic device(s) may be reused to control the temperature of the battery by performing a heat transfer action in a thermal medium coupled between the battery and the electronic device. In an embodiment this may be controlled by predicting a temperature, heat output or other heat source parameter associated with the electronic device. For example, the temperature of a heat shield in the electronic device may be predicted based on the current and predicted operation parameters of the electronic device, such as processor utilization, number of active (and predicted) wireless channels, power consumption and so on. The electronic device may be thermally coupled to a battery enclosure by controlling the flow of water in pipes for example. In other embodiments, this management of heat transfer to the battery may be supplemented by performing a battery cooling action such as controlling the supply of cold water from a nearby lake to the battery. Other cold sources may include an air cooled radiator. In some embodiments, the management of heat transfer to the battery may alternatively or additionally be supplemented by performing an electronic device cooling action using the cold source.

Some embodiments may use machine learning agents to managing heat transfer to the battery. In some embodiments, the performance of various heating or cooling actions may depend on the mode of operation of the battery, for example idle or float charge, charging, discharging, which may each correspond to a different prescribed battery temperature for optimal operation in that mode. The battery may comprise a number of sub-batteries or battery strings, for example in an enclosure, and these sub-batteries may be managed separately, for example because they are of different battery types and/or because they are in different modes of operation from time to time.

RRUs and other electronic devices can dissipate large amounts of heat while they are operating. The amount of heat dissipated depends on a number of factors such as their construction, output power, current load, environmental conditions such as air temperature, device deterioration, device cleanliness and other factors. Typically, this heat is something that needs to be removed from the system since typical modern processing units are designed to monitor their temperature and if that temperature is above a certain threshold that may cause the processing unit to throttle or perform other energy saving measures such as micro-sleeping and adjusting other operational parameters (e.g. combining physical resource block symbols and handing over UEs to other cells in RRU) which degrades performance.

If throttling or other power saving measures does not yield sufficient improvements in operating temperature, and the load that this component is receiving is not reduced, the processing unit may be designed to implement more drastic energy saving measures (e.g. reduce transmission power) and/or to shutdown to protect itself from burning. Known approaches to cooling such electronic devices range from heatsinks and fans, to climate control units to liquid-based cooling. Some embodiments by re-using some of this “waste” heat from the electronic device to manage battery temperature, reduces overall power consumption.

Batteries such as lithium-ion are best operated within a certain prescribed temperature range such as between 20 and 55 degrees Celsius (C) where below 20° C. such batteries will have lower capacity while above 55° C. their life expectancy diminishes. In addition, this type of battery may optimally require a temperature between 18 and 21 degrees when charging and if colder should be warmed up before being charged. The prescribed temperatures for different modes of operation may vary by battery manufacturer and type.

Some embodiments may reduce the need for dedicated heating and cooling elements within the battery enclosure by re-using the heat dissipated by an electronic device that it is powering or otherwise electrically coupled to. A predictive model may be employed for the usage of radio unit, energy consumption and heat dissipation and the usage of batteries to proactively control the temperature of batteries to ensure that they are operating within their prescribed range depending on their usage (e.g., charging/discharging). Cold sources may also be utilized to mix cold and warm water for example, to achieve the desired temperature.

Beyond RRUs, some of the embodiments may also apply to other electronic devices such as Internet of Things (IoT) servers or other edge compute devices such as gaming servers having a GPUs with a large number of cores requiring a lot of power and consequently generating a lot of heat. The heat from these sources can be channeled to a nearby battery enclosure which can then be used to maintain the temperature of the different batteries to the desired temperature. The nearby battery enclosure can then be used to sustain the operation of the edge device in the case where those devices are operating on batteries either to avoid using the local power grid to save costs, reduce carbon prints etc. or because that grid is not available.

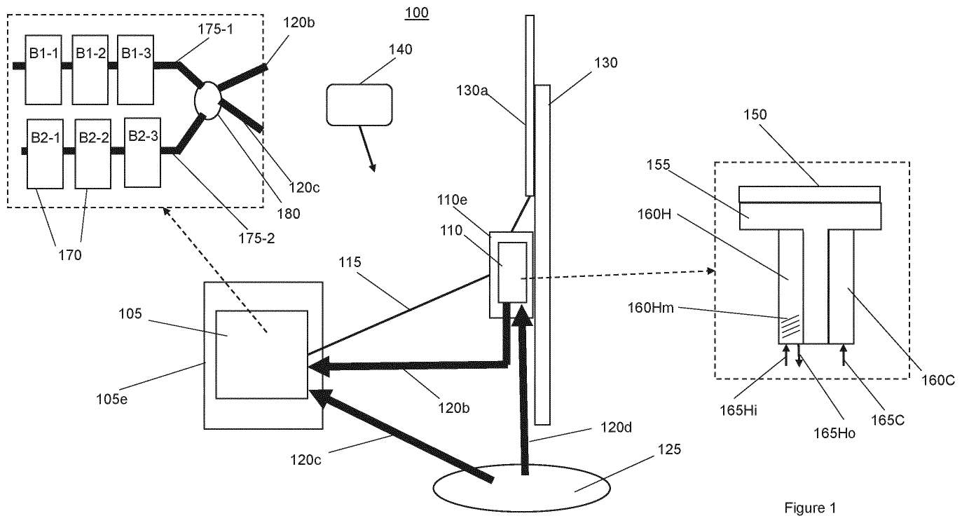

FIG. 1 illustrates a system according to an embodiment. The system 100 comprises a battery 105 in a battery enclosure 105e which is electrically coupled to an electronic device 110 by an electrical conductor 115. The electronic device 110 may be a RRU in a device enclosure 110e which is installed on or near an antenna mast 130 carrying an antenna 130a also electrically connected to the RRU 110. A thermal medium 120b is coupled between the battery 105 and electronic device 110. The thermal medium may comprise a liquid conduit controllable using pumps and valves (not shown). The thermal medium 120b enables a heat transfer action to be performed by which heat dissipated from the electronic device may be transferred to the battery in order to control the battery temperature. For example, a flow of warm water from the electronic device to the battery may be controlled to increase battery temperature.

A second thermal medium 120c is coupled between the battery 105 and a cold source 125 such as a nearby lake or a cold water tank. This thermal medium 120c enables a battery cooling action to be performed, for example controlling cold water flow from the lake 125 to the battery in order to reduce battery temperature. A third thermal medium 120d is coupled between the electronic device 110 and the cold source 125. This thermal medium 120d enables an electronic device cooling action to be performed, for example controlling cold water flow from the lake 125 to the electronic device in order to reduce the temperature of the electronic device. Fluids other than water may be used in some of the thermal mediums, or these may comprise solid thermal conductors.

A detail of heat transfer associated with the electronic device is shown to the right of the FIG. 1 showing a printed circuit board (PCB) 150 of the electronic device 110 which is thermally coupled to a heat sink 155. The board will have many electronic components which generate heat, and the heat sink is arranged to remove at least some of this heat in order to maintain a desired working temperature for the board components. Two heat exchangers 160H, 160C are thermally coupled to the heat sink 155, and may simply comprise a liquid tank or may include a matrix of capillaries 160Hm or other design features. The heat exchangers may simply add or remove a liquid such as water, or they may be arranged to accommodate a flow of liquid (open loop); or they may use a recirculating fluid to remove heat from the enclosure (closed loop) with a further thermal medium used to transfer this to the battery enclosure. Various other arrangements may alternatively be employed, for example the entire circuit may be submerged into water with a cold water pipe providing cooler water flow and a hot water pipe providing warm water flow. In some embodiments more than one electronic device 110 may be used as a heat source for transferring heat to the same battery.

In the embodiment illustrated, one of the heat exchangers 160H is connected to or forms part of the first thermal medium 120b coupled to the battery 105 and supplies warm water for heating the battery. A flow of liquid into 165Hi and out of 165Ho is shown. The other heat exchanger 160C is connected to or forms part of the third thermal medium 120d coupled to the battery 105 and receives cold water from the lake 125 to cool the electronic device. A simple flow 165C into the heat exchanger is shown, however other arrangements are possible including for example cold water flowing into a single heat exchanger and out towards the battery.

A detail of the battery 105 is shown to the left of the FIG. 1 showing a matrix of sub-batteries 170. The sub-batteries are individual battery strings (B1-1-B1-3, B2-1-B2-3) installed in the battery enclosure 110e and may comprise the same or different battery types. Some of the sub-batteries (B1-1-B1-3) may operate in a different mode such as charging, compared with other sub-batteries (B2-1-B2-3) which may be discharging; this may be implemented using partitioned or separate enclosures. Because these different operations may correspond to different prescribed battery temperatures, the temperatures of the sub-batteries may be separately controlled. For example, one row of sub-batteries (B1-1-B1-3) in a corresponding enclosure may be heated using warm water from the RRU 110 and another row of sub-batteries (B2-1-B2-3) may be cooled using cold water from the lake 125.

In other arrangements, the warm water from the first thermal medium 120b and the cold water from the second thermal medium 120c may be mixed at a mixer 180.

Mixed water at one temperature may be forwarded to one group of sub-batteries (B1-1-B1-3) via associated pipework 175-1 and mixed water at a different temperature may be forwarded to another group of sub-batteries (B2-1-B2-3) via associated pipework 175-2.

A controller 140 is arranged to manage heat transfer to or from the battery 105 and electronic device 110. This may be achieved by determining battery temperature and predicting heat generated by the electronic device and controlling performance of a heat transfer action from the electronic device to the battery in order to achieve a prescribed battery temperature, which may depend on the operational mode of the battery; or sub-batteries as appropriate. Similarly, the controller 140 may control performance of battery cooling and electronic device cooling actions.

The controller may be implemented locally, for example in a battery enclosure or electronic device controller, or may be implemented remotely in a cloud server for example. The control may control pumps, valves or other mechanisms for controlling heat flow between the battery enclosure 105e, electronic device enclosure 110e and cold source 125.

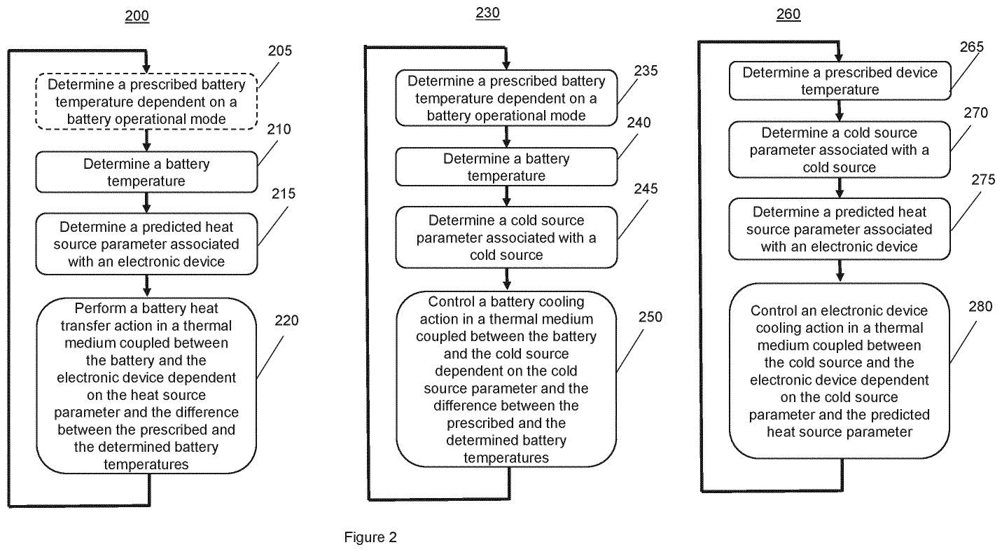

FIG. 2 illustrates methods of managing heat transfer operations associated with a battery electrically coupled to an electronic device, such as those described in association with FIG. 1, although other arrangements may be similarly managed. One or more of these methods may be implemented by the controller 140 or any other suitable apparatus.

A first method 200 manages heat transfer to a battery (e.g. 105) electrically coupled to an electronic device (e.g. 110), for example to increase a battery temperature. At 205, the method may optionally determine a prescribed battery temperature, which may be dependent on an operational mode of the battery 105, for example charging or discharging. Alternatively, the prescribed battery temperature may be predetermined and/or programmed into the system. The method may be used for individual or groups of sub-batteries with different prescribed temperatures, for example one group of sub-batteries may be charging whilst another group is discharging and/or of a different battery type or manufacturer.

At 210, the method 200 determines a battery temperature which may be the current operational temperature. This may be implemented by monitoring a temperature sensor or any other suitable device located within a battery enclosure 105e for example. Individual thermometers may be associated with respective sub-batteries 170 in the enclosure. The battery temperature may be inferred from a temperature sensed within an enclosure containing one or may batteries. The battery(s) may be associated with a battery management circuit arranged to control the operational mode in which the battery is operated, for example by responding to controls from the electronic device and using appropriate switching of the battery terminals between the electronic device and a power charging source such as solar cells.

At 215, the method determines a predicted heat source parameter associated with the electronic device 110. This may be a predicted temperature of a heat sink 155 in an electronic device enclosure 110e, or a predicted heat dissipation level. The predicted heat source parameter is predicted using operational parameters associated with the electronic device 110. For an RRU these might include: number of radio resource control (RRC) connections; physical resource block utilization; power consumed; output power; RRU type; RRU energy efficiency, incoming/outgoing number of handovers, handover oscillation and many other factors, and also may include the measured or predicted ambient temperature. For an IoT or edge server, these might include: number of processes; Central Processing Unit (CPU) utilization; Graphical Processing Unit (GPU) utilization; power consumed; output power; server type; server energy efficiency, memory footprint of each operation (ML operations have substantially larger footprint then regular processes), whether the process uses the GPU or not, the frequency of the CPU or of the GPU as this can vary depending on the load (number of operations) it is handling in parallel but also due to other reasons such as overclocking.

At 220, the method 200 performs a battery heat transfer action in a thermal medium 120b coupled between the battery 105 and the electronic device 110, dependent on the predicted heat source parameter and a difference between the prescribed battery temperature and the determined battery temperature. For example, warm water may be moved from the electronic device 110 to the battery 105 by controlling pumps associated with the first thermal medium 120b.

A second method 230 manages heat transfer away from the battery, for example to reduce battery temperature. At 235, the method may determine a prescribed battery temperature, which may be dependent on an operational mode of the battery 105, for example charging or discharging.

At 240, the method 230 determines a battery temperature, for example as described above at 210. At 245, the method determines a cold source parameter associated with a cold source. The cold source may be a nearby lake or cold water tank and the cold source parameter may be the temperature of the water which could be monitored using a temperature sensor or estimated based on the season for example. An embodiment may also utilize geothermally available water of a known regular temperature.

At 250, the method 230 performs a battery cooling action in a thermal medium coupled between the battery 105 and the cold source 125, dependent on the cold source parameter and a difference between the prescribed battery temperature and the determined battery temperature. For example, cool water may be moved from the cold water tank or lake 125 to the battery 105 by controlling pumps associated with the second thermal medium 120c.

A third method 260 manages heat transfer away from an electronic device (e.g. 110), for example to reduce electronic device temperature. At 265, the method may determine a prescribed electronic device temperature, which may be dependent on an operational mode of the electronic device 110.

At 270, the method 260 determines a cold source parameter associated with a cold source. This may be implemented as described above at 245. At 275, the method determines a predicted heat source parameter associated with the electronic device 110. This may be implemented as described above at 215.

At 280, the method 260 performs an electronic device cooling action in a thermal medium coupled between the cold source and the electronic device 110, dependent on the predicted heat source parameter and a difference between the cold source parameter and the predicted heat source parameter. For example, cold water may be moved from the cold water tank or lake 125 to the electronic device 110 by controlling pumps associated with the third thermal medium 120d.

These methods 200, 230, 260 may be implemented by a controller using predetermined algorithms to control pumps or other mechanisms for controlling the thermal mediums to perform the described actions. In other embodiments, machine learning agents may be trained and used to implement these methods as described in more detail below.

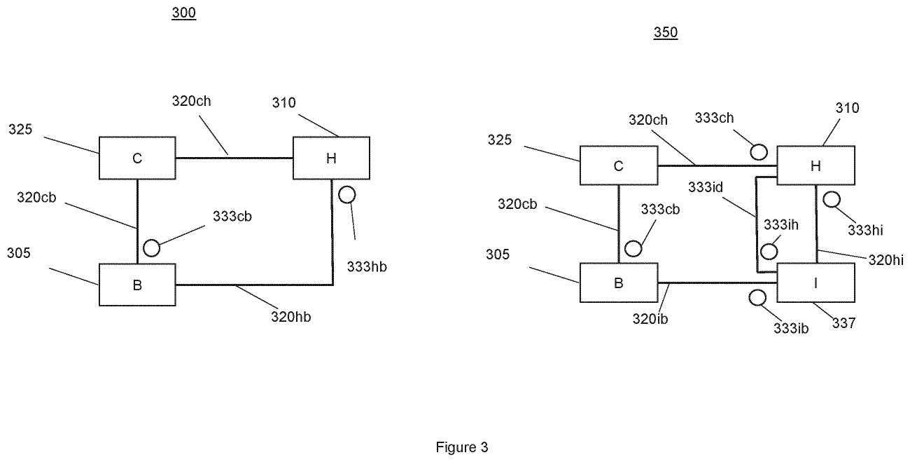

FIG. 3 illustrates arrangements of thermal mediums that may be used by some embodiments to perform heat transfer actions to and from a battery and/or an electronic device. One of these arrangements, or a different arrangement may be used in the system of FIG. 1 and/or by the methods of FIG. 2.

In the arrangement 300 on the left of FIG. 3, a battery (B) 305 may be thermally coupled to a heat source (H) such as an electronic device 310 using a fluid carrying conduit 320hb and an associated pump 333hb. A battery heat transfer action may be performed by actuating the pump 333hb to move a fluid such as water warmed by the electronic device 110 to the battery 305.

The battery 305 may be thermally coupled to a cold source (C) such as a nearby lake 325 using another fluid carrying conduit 320cb and associated pump 333cb. A battery cooling action may be performed by actuating the pump 333cb to move a fluid such as cold water from the lake to the battery 305.

The electronic device 310 may be thermally coupled to the cold source 325 using another fluid carrying conduit 320ch and the pump 333hb. An electronic device cooling action may be performed by actuating the pump 333hb to move a fluid such as cold water from the lake to the electronic device 310. In this arrangement, fluid such as water may flow from the lake to the electronic device where it is heated continue to flow to the battery. Thus, in this embodiment, the electronic device cooling action and the battery heating action may occur together by controlling operation of the pump 333hb. In an alternative arrangement, separate pumps may be provided for moving water from the lake to the electronic device, and for moving water from the electronic device to the battery, such that these flows can be controlled independently.

In the arrangement 350 on the right of the FIG. 3, a battery (B) 305 may be thermally coupled to a heat source (H) such as an electronic device 310 using a combination of fluid carrying conduits 320ib, 320hi, 320ih, associated pumps 333ib, 333ih, 333hi and an intermediate tank 337. A battery heat transfer action may be performed by controlling one of more of these pumps 333ib, 333ih, 333hi to move a fluid such as water between the electronic device 110, the intermediate tank 337, and the battery 305. In one arrangement, pumps 333hi and 333ih may be controlled to periodically circulate water between the electronic device 110 and the intermediate tank 337 in order to cool the electronic device and heat the water in the intermediate tank 337. Pump 333ib may be independently controlled to move warm water from the intermediate tank 337 to the battery 305 as required.

The battery 305 may also be thermally coupled to the cold source (C) using another fluid carrying conduit 320cb and associated pump 333cb. A battery cooling action may then be performed by actuating the pump 333cb to move a fluid such as cold water from the lake to the battery 305.

The electronic device 310 may also be thermally coupled to the cold source 325 using another fluid carrying conduit 320ch and associated pump 333ch. An electronic device cooling action may be performed by actuating the pump 333ch to move a fluid such as cold water from the lake to the electronic device 310. In this arrangement, this fluid flow is controlled independently of water flows associated with the moving water from the electronic device to the intermediate tank 337 and battery 305.

Various methods for calculating a predicted heat source parameter may be employed. For example, a lookup table may be used to convert predicted heat dissipation to degrees Celsius, with the predicted heat dissipation determined using operational parameters of the electronic device such as input power, CPU utilization, number of processes and so on. Again, a lookup table may be used to make this conversion depending on the type of electronic device. Equations may also be used, for example:

$$temperature\_change = \frac{heatdissipation / mass}{liquidheatcapacity} = \frac{heatdissipation}{liquidheatcapacity * mass}$$

Provides a temperature change in Celsius for the heat dissipation of different electronic devices such as single band RRU and triple band RRU. The heatdissipation (Watts or J/s) is predicted using operational parameters of the electronic device, mass (Kg) is the mass of liquid such as water in the heat exhanger and the liquidheatcapacity (J/(Kg*K)) is the specific heat capacity of the liquid.

Heat dissipation could be simply determined using:

$$heatdissipation = average\_energy \_consumption - average\_utilized \_output \_power * duration$$

Where we know the energy consumption for a device and its output power. From the heat dissipation, the amount of heat produced from the electronic device for water heating can be calculated. Not all heat may be transferred to a heatsink and not all heat from the heatsink may be transferred to the water and so a safety margin may be used, or more accurate calculations determined using experimentation for example. The heat loss associated with moving the water from the electronic device to a warm water tank or directly to a battery enclosure may be calculated using:

$$heatloss = \frac{( 2 * π * λ * ( T h - T min ) )}{ln ( \frac{D}{d} )}$$

where λ is the thermal conductivity of the insulating material of the pipe, Th is the prescribed temperature for the battery, Tmin is the ambient temperature, D is the diameter of the pipe including insulation and d is the outer diameter of the pipe without insulation. The length of the pipe may be used as a scaling factor.

As an example, if we want to maintain a temperature of 25 degrees Celsius in an area where the lowest temperature is −5, in a pipe using felt (wool) as an insulator (0.052) then the loss is about 7 W/m or 0.22 Celsius for a pipe with a diameter of 30 mm. A 60 mm pipe achieves 5.19 W/m or 0.15 Celsius.

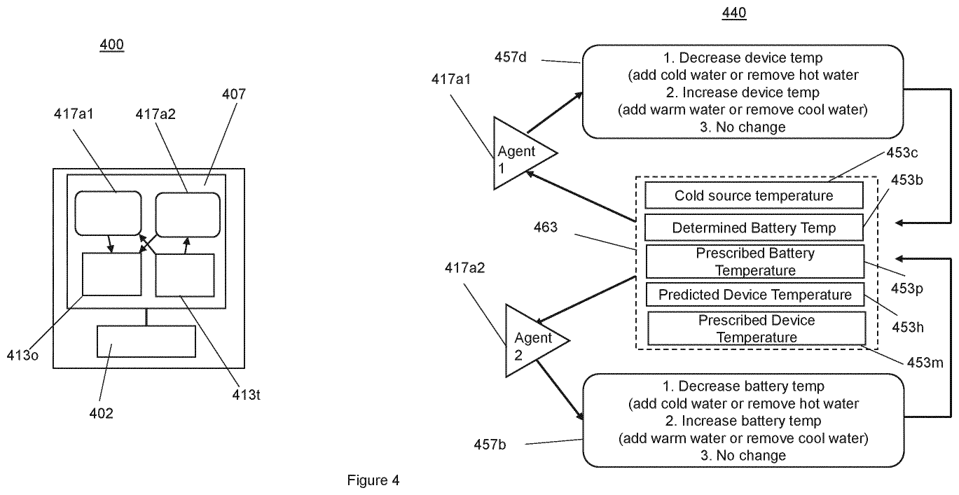

FIG. 4 illustrates an apparatus for managing heat transfer to a battery according to an embodiment. The apparatus 400 comprises a processor 402 and memory 407 and may be configured to perform one or more of the methods of FIG. 2 and/or may be used as the controller for the system in FIG. 1. The memory 407 comprises instructions 4130 which when executed on the processor 402 cause this to perform one or more heat transfer actions. The memory 407 also comprises one or more machine learning agents 417a1, 417a2 used to perform the heat transfer actions. The memory 407 may also comprise instructions 413t to train the one or more machine learning agents 417a1, 417a2.

A flow diagram 440 to the right of the FIG. 4, illustrates operation of the apparatus using two trained machine learning agents 417a1, 417a2 wherein the training process of the machine learning agents is described in detailed later. A combined input state space 463 for both agents is shown for simplicity, although it would be recognized that each agent will have its own state space. The state spaces comprise a cold source temperature 453c, a determined battery temperature 453b, a prescribed battery temperature 453p, a predicted heat source parameter or device temperature 453h and a prescribed battery temperature 453m. Other state space parameters may be used, for example ambient temperature as well as more parameters that may be used in to determine those other parameters. For example, battery mode of operation may be used instead of or in combination with prescribed battery temperature 453p. Operational parameters of the electronic device such as processor utilization or power input may be used directly instead of an already calculated predicted device temperature 453h.

In one example, the first machine learning agent 417a1 may use cold source temperature 453c, prescribed device temperature 453m and predicted device temperature 453h to control the temperature of the electronic device 457d. The agent 417a1 may perform one of three operations 457d depending on these state space inputs. The device temperature may be decreased 457d1, for example by moving cold water to the device and/or removing warm water. The device temperature may be increased 457d2, for example by moving warm water (e.g. from intermediate tank 337) to the electronic device and/or by removing cool water. These actions may be performed by controlling pumps associated with fluid conduits between the electronic device, battery and cold source. The device temperature may also be maintained 457d3 by taking no action.

The second machine learning agent 417a2 may use cold source temperature 453c, prescribed battery temperature 453p, predicted device temperature 453h and determined battery temperature 453b to control the temperature of the battery 457b. The agent 417a2 may perform one of three operations 457b depending on these state space inputs. The battery temperature may be decreased 457b1, for example by moving cold water to the battery and/or removing warm water. The battery temperature may be increased 457b2, for example by moving warm water (e.g. from the intermediate tank 337 or directly from the electronic device) to the battery and/or by removing cool water. These actions may be performed by controlling pumps associated with fluid conduits between the electronic device, battery and cold source. The battery temperature may also be maintained 457b3 by taking no action.

In one example the state space of the first agent 417a1 may comprise prb_utilization, rrc_connections, energy_consumed, output_power, cold_water_flow, warm_water_flow, ambient_temperature, wanted_temperature, current_temperature for a series of N time steps. The cold_water_flow and hot_water_flow may be actual flow rates of water to the battery, or they could be simple binary states of a pump or valve used to control that water. The action space for the first agent may comprise decrease temperature of the electronic device (e.g. by adding cool water), increase device temperature, or maintain device temperature. This may be implemented by switching a pump on/off or controlling a valve as open or shut. More nuanced control is also possible such as controlling fluid flow rates, pump speed, or valve rotation.

A simple reward function may be implemented for where the agent is controlling a degree of rotation of a valve. The reward function is:

$$agent 1 reward = \{ \frac{{r}_{i - 1} + \vert WT - CT \vert if done}{{r}_{i - 1} - \vert WT - CT \vert if not done}$$

Where WT and CT are the wanted or prescribed and current temperatures of the electronic device respectively. rᵢ₋₁ is the previous reward that has been acquired from the previous episode. To start, the reward may be set to zero, r₀=0.

In one example the state space of the second agent 417a2 may comprise battery_state (charging, not charging, idle or float charge, fast_charging), battery temperature (BT), cold_water_flow, warm_water_flow, ambient_temperature. The action space for the second agent may comprise decrease temperature of the battery (e.g. by adding cool water), increase battery temperature (e.g. by adding warm water), or maintain battery temperature. This may be implemented by switching a pump on/off or controlling a valve as open or shut. More nuanced control is also possible such as controlling fluid flow rates, pump speed or valve rotation.

A simple reward function for the second agent may be:

$$agent 2 reward = \{ \frac{{r}_{i - 1} + \vert T ( batterystate ) - BT \vert if done}{{r}_{i - 1} - \vert T ( batterystate ) - BT \vert if not done}$$

Where T(battery state) is the prescribed battery temperate for the particular operational state (e.g. charging or discharging) and BT is the determined or current battery temperature.

Replacing this with a single agent will expand the state space to include both sets and will also expand the action space to include control of additional valves or pumps. This results in the agent being more complex to train and may require a DQN (Deep Q Learning) model whereas Q-tables may be sufficient for two agents.

In an alternative embodiment, a single machine learning agent may be used to control both the device and battery temperatures, using the combined state space inputs. However, using two agents may reduce the training time and cost.

The machine learning agents 417a1, 417a2 may be trained using a suitable training set and may be continually trained when operational to improve performance. Transfer learning from agents in similar systems may be used to reduce training time and cost.

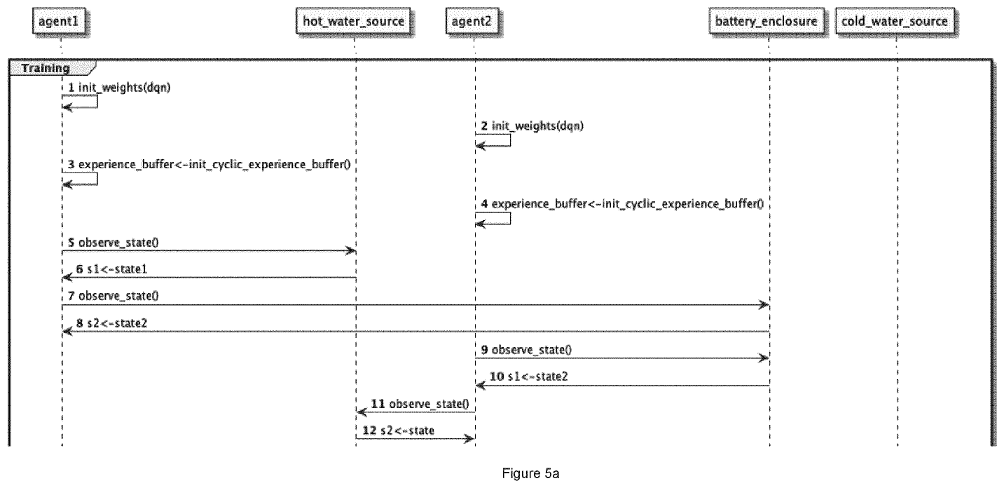

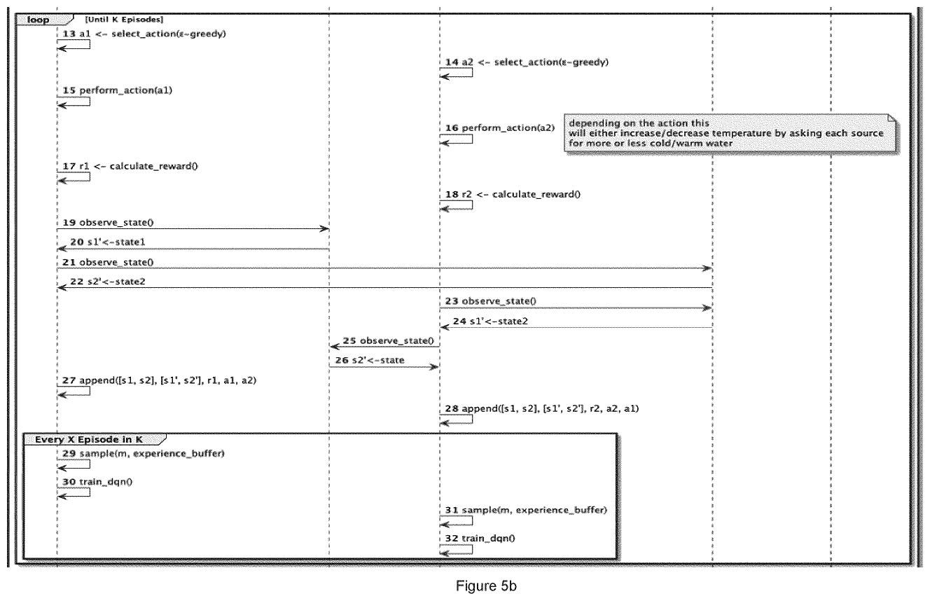

Sequence diagrams for training the machine learning agents 417a1 and 417a2 are shown in FIGS. 5a and 5b. FIG. 5a shows the initialization process and FIG. 5b shows the subsequent training loops. Actions at the following entities are illustrated: agent1 417a1; hot_water_source such as an electronic device 310; agent2 417a2; battery_enclosure corresponding to a battery 305; and cold_water_source such as a lake 325.

In an embodiment, training of the agents uses reinforcement learning (RL) which employs an agent that learns from its environment and based on the input from the environment (state space), a set of actions and a reward function, the agent learns to select from the available actions in order to optimize the reward. This allows for many and varied operational conditions of a battery-electronic device system to be catered for in re-using some of the heat dissipated by the device to be used to manage the battery temperature. For example, the agent or agents can consider many inputs such as whether or not there is a lot of traffic for a RRU, or if the traffic is to be handed over to another RRU, or the operations that take place in the case of an IoT edge device

This type of information correlates with the usage of the electronic device and this correlates with the heat that the electronic device is going to produce. Therefore, this detailed operational information can enable better calibration of the RL algorithm's decision process. This also allows the approach to be easily adaptable where different sets of operating parameters are available, or different types of electronic devices or batteries are involved. The agents may also be able to adapt following an upgrade or other change to the electronic device and/or battery. Further considerations may include the age of the battery which may impact factors such as the prescribed battery temperature and/or the level of heat transfer required to achieve this.

For each agent a DQN (Deep Q-Learning) loop is used for training, however, in this case the action performed by one agent has an effect on the action of the other and therefore the two agents are trained in parallel but in isolation which allows them to develop their own policies. However, their individual learning is augmented by exposing their actions indirectly to each other since they both observe a common state space. Even though this diagram presents the training of agent2 and to follow that of agent1, in practice these steps can be performed in parallel. In addition, during this training the two agents may be synchronized by using a common clock that timestamps the events that occur (the observations from the different state spaces) to ensure that the two agents are both observing their environment at the same time.

Steps 1 and 2—Agent1 and Agent 2 initiate the weights of their own DQN with a random distribution of values

Steps 3 and 4-Agent1 and Agent 2 initiate their corresponding buffers which will be used to record tuples of (old state, action, new state, reward) to train their corresponding DQN models.

Steps 5 to 12-Agent1 and Agent2 collect information about the state of the cold_water_source and the state of the hot_water_source. In addition, information about the state associated with Agent1 is included, for example in this case RRU or IoT radio utilization or CPU/GPU utilization, and so on as previously described.

Similarly information associated with Agent2 is included such as the battery temperature and operational mode.

Steps 13 to 28-Agent1 and Agent2 perform random actions (greedy policy suggests to take a random action with probability ε (in the unit interval [0, 1]) and the action that yields the highest reward max (Q(a)) with probability 1-ε). Once each action is performed by each agent then the agents observe again the state space, calculate their corresponding rewards, and record this experience as a tuple in the experience buffer which has been initialized in Steps 3 and 4.

Steps 29-32-In these steps a set of two different samples is extracted from each experience buffer (for the same timeframe) to train the two agents

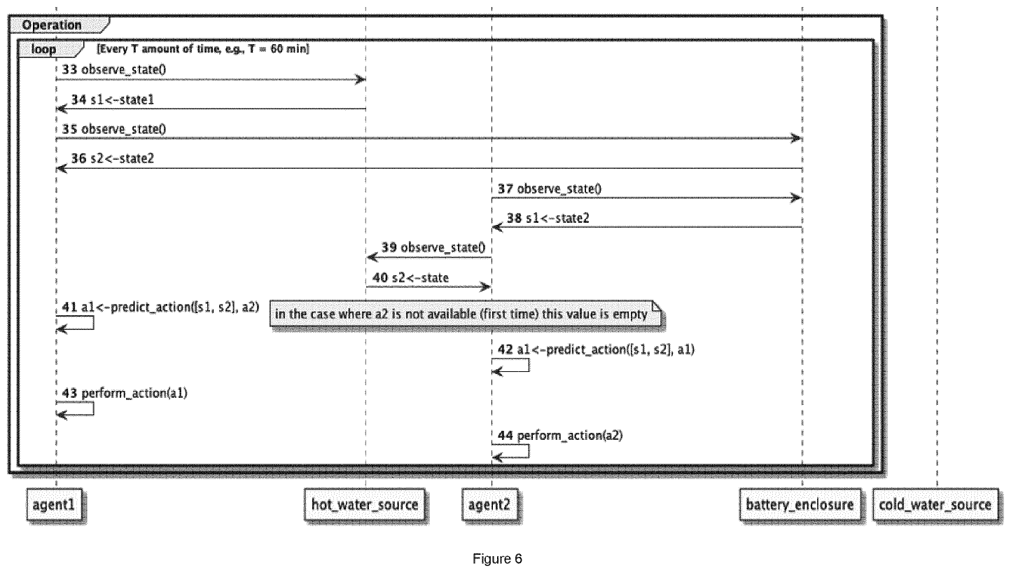

FIG. 6 illustrates operational steps for the agents Agent1 417a1 and Agent2 417a2 trained in the training method of FIGS. 5a and 5b.

Steps 33-44—These steps are similar to the training phase described previously, but now the DQNs are no longer trained but instead rely on their predictions to perform an action as opposed to choosing based on the ε-greedy policy described previously.

Embodiments may provide a number of advantages. For example, heat generated by an electronic device is reused to manage the heat associated with a battery that may be electrically connected to the electronic device. This reduces the amount of energy wasted from the electronic device whilst also reducing the energy required to maintain the battery at a prescribed temperature. Improved temperature control of the battery improves battery life and performance. Similarly reducing overheating of the electronic device improves device life, operation and utilization. The temperature management may also be dynamic and linked to the operation of the battery, for example charging or discharging, idle or under heavy load.

Whilst the embodiments have described with respect to particular electronic devices such as RRU and edge servers, other electronic devices may also benefit from some embodiments, especially where these are remotely located.

Some or all of the described apparatus or controller functionality may be instantiated in cloud environments such as Docker, Kubernetes or Spark. This cloud functionality may be instantiated in the network edge, apparatus edge, in the factory premises or on a remote server coupled via a network such as 4G or 5G. Alternatively, this functionality may be implemented in dedicated hardware.

Modifications and other variants of the described embodiment(s) will come to mind to one skilled in the art having the benefit of the teachings presented in the foregoing descriptions and the associated drawings. Therefore, it is understood that the embodiment(s) is/are not limited to the specific examples disclosed and that modifications and other variants are intended to be included within the scope of this disclosure. Although specific terms may be employed herein, they are used in a generic and descriptive sense only and not for purposes of limitation.

1. A method for managing heat transfer to a battery electrically coupled to an electronic device, the method comprising:
determining a battery temperature of the battery and a predicted heat source parameter associated with the electronic device;
performing a battery heat transfer action in a thermal medium coupled between the battery and the electronic device dependent on the predicted heat source parameter and a difference between a prescribed battery temperature and the determined battery temperature.

2-18. (canceled)

19. A method of training a first machine learning agent to perform a battery heat transfer action in a thermal medium coupled between a battery and an electronic device and training a second machine learning agent to perform an electronic device cooling action in a device cooling thermal medium coupled between the electronic device and a cold source; the method comprising:
updating state space values comprising a determined battery temperature, a predicted heat source parameter, a prescribed battery temperature, a prescribed device temperature and a cold source parameter;
inputting the predicted heat source parameter, the prescribed device temperature and the cold source parameter into the first machine learning agent to generate an electronic device cooling action;
inputting the determined battery temperature, the predicted heat source parameter and the prescribed battery temperature into the second machine learning agent to generate a battery heat transfer action, wherein the state space values are input into the first and second agents in the same time period;
rewarding the first machine learning agent dependent on a difference between the predicted heat source parameter and the prescribed device temperature;
rewarding the second machine learning agent dependent on a difference between the determined battery temperature and the prescribed battery temperature;
repeating the updating, inputting and rewarding until a training threshold condition is reached.

20. An apparatus for managing heat transfer to a battery electrically coupled to an electronic device; the apparatus comprising a processor and memory containing instructions executable by said processor to:
determine a battery temperature of the battery and a predicted heat source parameter associated with the electronic device;
perform a battery heat transfer action in a thermal medium coupled between the battery and the electronic device dependent on the predicted heat source parameter and a difference between a prescribed battery temperature and the determined battery temperature.

21. The apparatus of claim 20, wherein
the prescribed battery temperature is dependent on an operational mode of the battery, and
the operational mode of the battery is one of the following: charging; discharging; idle or float charge; fast charging.

22. (canceled)

23. The apparatus of claim 21, wherein the battery comprises two sub-batteries each having a different respective prescribed battery temperature, and the apparatus is configured to perform the battery heat transfer action in respect of each sub-battery and dependent on the difference between predicted heat source parameter and the respective prescribed battery temperature.

24. The apparatus of claim 20, wherein the heat flow action comprises transferring heat from the electronic device to the battery in response to the determined battery temperature being below the prescribed battery temperature.

25. The apparatus of claim 20, wherein the thermal medium is a fluid carrying conduit between the battery and the electronic device and the heat transfer action comprises changing a fluid flow in the fluid carrying conduit.

26. The apparatus of claim 25, wherein the battery heat transfer action comprises controlling a pump coupled to the fluid carrying conduit.

27. The apparatus of claim 25, wherein the thermal medium comprises an intermediate store and the heat transfer action comprises changing a fluid flow between the intermediate store and the battery and/or changing a fluid flow between the intermediate store and the electronic device.

28. (canceled)

29. The apparatus of claim 20, wherein
the predicted heat source parameter is predicted using one or more operational parameters or predicted operational parameters of the electronic device, and
the electronic device is a Remote Radio Unit (RRU), and the operational parameters comprise one or more of the following: number of radio resource control connections; physical resource block utilization; power consumed; output power; RRU type; RRU energy efficiency.

30. The apparatus of claim 20, wherein
the predicted heat source parameter is predicted using one or more operational parameters or predicted operational parameters of the electronic device, and
the electronic device is a computer server, and the operational parameters comprise one or more of the following: number of processes; Central Processing Unit (CPU) utilization; Graphical Processing Unit (GPU) utilization; power consumed; output power; server type; server energy efficiency.

31. The apparatus of claim 20, the apparatus configured to perform the battery heat transfer action by controlling a battery cooling action in a battery cooling thermal medium coupled between the battery and a cold source dependent on a cold source parameter and the difference between the prescribed battery temperature and the determined battery temperature.

32. The apparatus of claim 20, the apparatus configured to perform an electronic device cooling action in a device cooling thermal medium coupled between the electronic device and a cold source dependent on a prescribed device temperature and the predicted heat source parameter.

33. The apparatus claim 20, the apparatus configured to perform a said transfer action based on historical values of at least the predicted heat source parameter and the determined battery temperature.

34. The apparatus of claim 20, the apparatus configured to perform the battery heat transfer action using a machine learning agent having an input state space comprising the determined battery temperature, the predicted heat source parameter, and the prescribed battery temperature.

35. The apparatus of claim 34, wherein
the apparatus is configured to perform an electronic device cooling action in a device cooling thermal medium coupled between the electronic device and a cold source dependent on a prescribed device temperature and the predicted heat source parameter, and
the machine learning agent is arranged to perform the battery cooling action and having the input state space additionally comprising the battery cold source parameter.

36. The apparatus of claim 34, when dependent on claim 32, the machine learning agent also arranged to control the electronic device cooling action.

37. The apparatus of claim 34, the apparatus configured to control the electronic device cooling action using a second machine learning agent having an input state space comprising the cold source parameter, the predicted heat source parameter and a prescribed device temperature.

38. An apparatus configured to train a first machine learning agent to perform a battery heat transfer action in a thermal medium coupled between a battery and an electronic device and training a second machine learning agent to perform an electronic device cooling action in a device cooling thermal medium coupled between the electronic device and a cold source; the apparatus comprising a processor and memory containing instructions executable by said processor to:
update state space values comprising a determined battery temperature, a predicted heat source parameter, a prescribed battery temperature, a prescribed device temperature and a cold source parameter;
input the predicted heat source parameter, the prescribed device temperature and the cold source parameter into the first machine learning agent to generate an electronic device cooling action;
input the determined battery temperature, the predicted heat source parameter and the prescribed battery temperature into the second machine learning agent to generate a battery heat transfer action, wherein the state space values are input into the first and second agents in the same time period;
reward the first machine learning agent dependent on a difference between the predicted heat source parameter and the prescribed device temperature;
reward the second machine learning agent dependent on a difference between the determined battery temperature and the prescribed battery temperature;
wherein the updates, inputs and rewards are repeated until a training threshold condition is reached.

39-40. (canceled)

41. A non-transitory computer readable storage medium storing a computer program comprising instructions which, when executed on a processor, cause the processor to carry out the method of claim 1.

42. (canceled)
